(19) United States
(12) Patent Application Publication
(10) Pub. No.: US 2021/0235709 A1
(43) Pub. Date: Aug. 5, 2021

(54) Apparatus and Method for Producing Scored Dough Pieces

(71) Applicant: General Mills, Inc., Minneapolis, MN (US)

(72) Inventors: Steven J. Cox, Long Lake, MN (US); Kara M. Hobart, New Hope, MN (US)

(73) Assignee: General Mills, Inc., Minneapolis, MN (US)

(21) Appl. No.: 16/780,127

(22) Filed: Feb. 3, 2020

(51) Int. Cl. A21C 11/12; A21C 11/10; A21C 13/02

(52) U.S. Cl. CPC A21C 11/12; A21C 13/02; A21C 11/10

(57) ABSTRACT

Scored dough pieces are produced by forming a dough piece, freezing the dough piece to produce a frozen dough piece and scoring the frozen dough piece to produce a scored dough piece having at least one score. The frozen dough piece can be scored with a saw blade, water knife or laser. In addition, a coating or treatment can be applied to the at least one score of the scored dough piece.

### BACKGROUND OF THE INVENTION

The present invention pertains to the art of food production and, more particularly, to the automated production of bread products.

Bakery operators sometimes purchase partially finished food products that are then finished in the bakery before being sold to consumers. For example, bakery operators can purchase frozen unproofed bread dough, which they thaw, proof and bake prior to sale. Depending on the desired bread product, the bread dough may be manually scored after proofing and before baking to help control expansion during baking and to give the resulting bread product its traditional look. Generally, it is preferred that the amount of time and labor required to finish such partially finished food products is kept to a minimum. Accordingly, it would be desirable to provide bread dough that is scored before purchase by bakery operators. Unfortunately, attempts to score bread dough during initial production have shown that it is difficult to make a cut in the dough that stays intact through freezing and thawing. Most attempts either produced shallow dents that did not open up or deeply segmented loaves that were misshaped.

### SUMMARY OF THE INVENTION

The present invention successfully achieves the goal of scoring bread dough before purchase by bakery operators by scoring dough pieces while the dough pieces are frozen. The scoring can be perfoinied in an automated process in various ways, preferably by a saw blade, water knife or laser. In one embodiment, a coating or treatment is applied at the scores.

Additional objects, features and advantages of the invention will become more readily apparent from the following detailed description of preferred embodiments thereof when taken in conjunction with the drawings wherein like reference numerals refer to common parts in the several views.

### BRIEF DESCRIPTION OF THE DRAWINGS

FIG. 1 is a flowchart illustrating a process for producing dough pieces in accordance with the present invention.

FIG. 2 is a perspective view of a portion of a production line for producing dough pieces in accordance with the present invention.

FIG. 3A is a front view of a conveyor belt and rotary cutter of the production line without a dough sheet in place.

FIG. 3B is a front view of a conveyor belt and rotary cutter of the production line with a dough sheet being cut.

FIG. 4 is a perspective view of a dough piece formed using the production line.

FIG. 5 is a top view of another portion of the production line.

FIG. 6 is a perspective view of a bread product produced in accordance with the present invention.

### DETAILED DESCRIPTION OF THE INVENTION

Detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for teaching one skilled in the art to employ the present invention. Additionally, as used in connection with the present invention, terms such as “parallel” and “perpendicular” do not necessarily require, for example, that the relevant items be perfectly parallel. Instead, these terms include a margin of error of +/−5° (regardless of whether the error is by design or due to inherent manufacturing limitations) so long as the error does not prevent the present invention from functioning as intended.

As discussed above, it would be desirable to provide bread dough that is scored before purchase by bakery operators. However, attempts to score bread dough during initial production have shown that it is difficult to make a cut in the dough that stays intact through freezing and thawing. The present invention successfully achieves this goal by scoring dough pieces while the dough pieces are frozen. Because the dough pieces are rigid when scored, they are deformed by the scoring but do not spring back to their original shape afterwards, which would tend to result in the scores closing back up. As a result, the scores remain intact all the way to receipt of the dough pieces by end users, i.e., bakers, and through the later production steps, i.e., thawing, proofing and baking. In addition, scoring dough pieces while the dough pieces are frozen allows the location and profile of the scores to be precisely placed on the dough pieces. Also, coatings or treatments can be applied at the scores because the scores remain open in the frozen dough pieces. Notably, this type of functional scoring is distinct from stamping bread dough with a design, as with a Kaiser roll for example. The functional scoring helps control expansion during baking (in addition to giving the resulting bread product its traditional look).

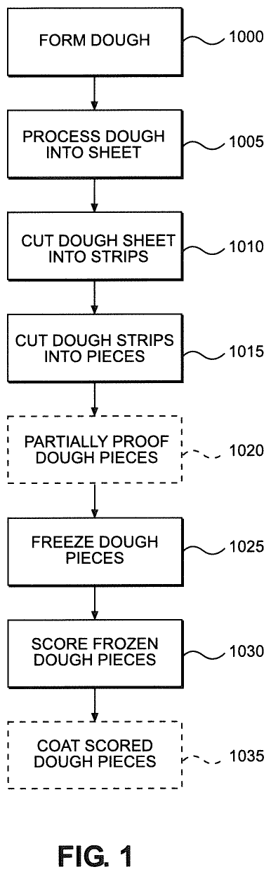

With reference to FIG. 1, a flowchart of a process for producing dough pieces in accordance with the present invention is shown. At step 1000, a dough is formed (in a batch maker or the like) and, at step 1005, the dough is processed into a dough sheet. The dough sheet is then cut into dough strips at step 1010, and the dough strips are cut crosswise into dough pieces at step 1015. Optionally, the dough pieces are partially proofed at step 1020. At step 1025, the dough pieces are frozen and, at step 1030, the frozen dough pieces are scored. If desired, a coating or treatment can be applied at the scores in step 1035. The scored dough pieces are then transported to end users who thaw, fully proof and bake the dough pieces to produce scored bread products.

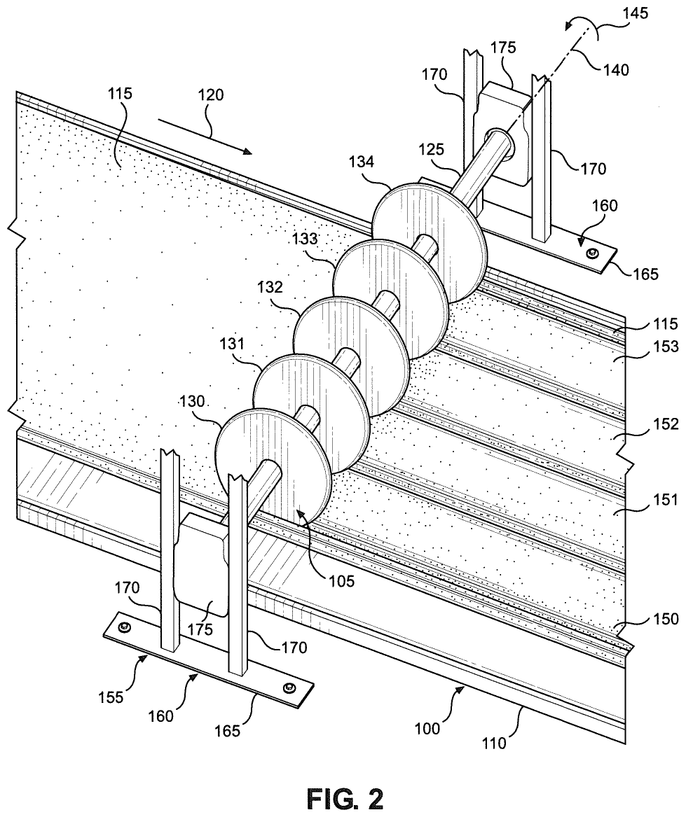

Turning to FIG. 2, a portion of a production line for producing dough pieces in accordance with the present invention is shown. Specifically, FIG. 2 shows a conveyor system 100 and a rotary dough cutter 105, which are used in step 1010. Conveyor system 100 includes a conveyor belt 110 for supporting and transporting a dough sheet 115. However, other conveyor systems known in the art can be used with the present invention. Conveyor belt 110 passes beneath rotary cutter 105 while traveling in a direction 120.

Rotary cutter 105 includes a driveshaft 125 and a plurality of circular blades 130-134. Driveshaft 125 is aligned perpendicular to direction 120. Accordingly, the axis of rotation for rotary cutter 105 (labeled 140) is also aligned perpendicular to direction 120. Rotary cutter 105 is configured such that contact between rotary cutter 105 and conveyor belt 110 or dough sheet 115 causes rotary cutter 105 to rotate in a direction 145 as conveyor belt 110 travels in direction 120. Alternatively, a motor and transmission (not shown) can be provided for driving rotary cutter 105, i.e., for causing rotary cutter 105 to rotate in direction 145.

Blades 130-134 are fixedly coupled to driveshaft 125 such that rotation of driveshaft 125 results in rotation of blades 130-134. Each of blades 130-134 is configured to cut dough sheet 115 as dough sheet 115 is being transported by conveyor belt 110. Specifically, blades 130-134 have blunt-edge dough engaging portions and are configured to cut dough sheet 115 into dough strips 150-153. Later, dough strips 150-153 are cut crosswise (i.e., in a direction parallel to driveshaft 125) to form a plurality of dough pieces. For purposes of the present invention, “cutting” (and its variants) means that the dough is cut all the way through. “Scoring” (and its variants) means that the dough is cut only part of the way through. Also, while five blades are shown, other numbers of blades can be used depending on the width of dough sheet 115 and the desired width of dough strips 150-153.

Rotary cutter 105 is supported above conveyor belt 110 by a support structure 155. The details of support structure 155 are not important to the present invention. However, it can be seen that support structure 155 includes identical left and right supports 160. Each support 160 has a base 165 and a pair of columns 170, supporting a bearing 175, which can incorporate a drive motor. Bearings 175 receive the ends of driveshaft 125 to facilitate rotation of rotary cutter 105.

As noted above, blades 130-134 are blunt-edge blades. The blunt-edge cutting of dough is described in U.S. Pat. No. 6,902,754, for example, which is incorporated herein by reference. This patent discloses a cutter including a blunt-edge dough-cutting or dough-engaging portions configured to pull a first surface or skin of a dough toward a second surface or skin of the dough when the cutter is impinged on the dough. This tends to pinch the two surfaces together and also, when desired, severs the dough, resulting in a dough product that more closely resembles a hand-formed dough product. That is, the dough product has rounded edges rather than straight or sharply-angled edges.

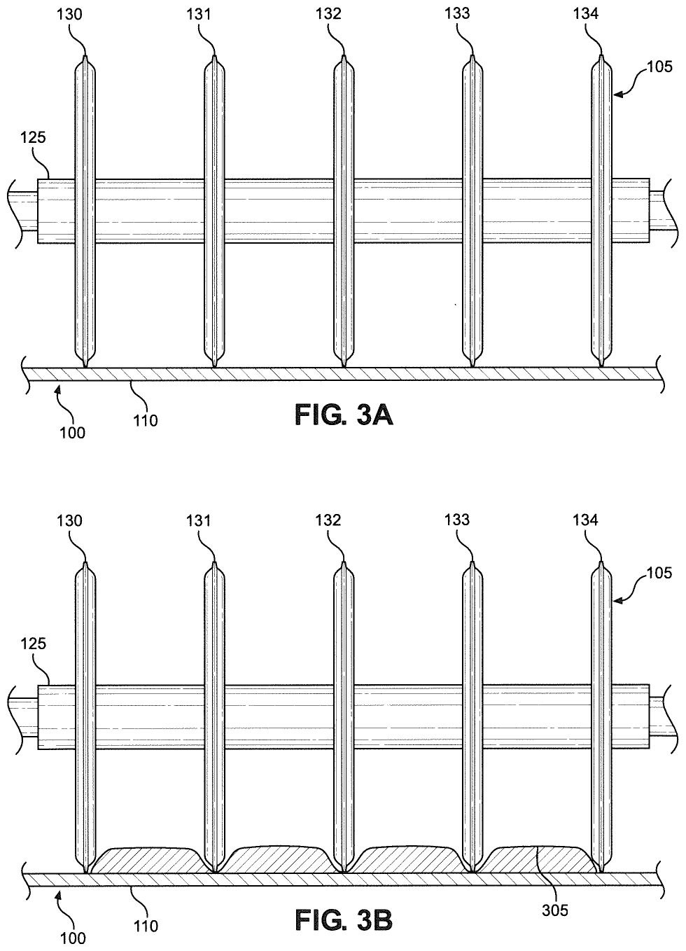

Turning to FIGS. 3A and 3B, a front view of conveyor belt 110 and rotary cutter 105 is provided. That is, the view of FIG. 3A is taken in the direction opposite direction 120. This view highlights the positioning of blades 130-134 relative to conveyor belt 110. Specifically, blades 130-134 are positioned in contact with, or just out of contact with, conveyor belt 110 so as to cut dough sheet 115 traveling along conveyor belt 110 (not shown in FIG. 3A). Each of blades 130-134 has a blunt-edge dough engaging portion (not separately labeled) designed to stretch the upper skin of the dough sheet and cut the dough as detailed more fully below.

With reference now to FIG. 2, a dough sheet 300 has an exposed upper dough skin and a lower dough skin (not separately labeled in this figure but discussed further below) supported on and transported by conveyor belt 110. Although not shown, it should be understood that the dough of dough sheet 115 is preferably formed in a batch maker or the like and then processed into dough sheet 115. Dough sheet 115 passes beneath rotary cutter 105, which is configured to continuously cut and score dough sheet 115 as dough sheet 115 is transported in direction 120. For example, Figure shows a plurality of dough strips 150-153 (also seen in FIG. 3B), which were formed from dough sheet 115 by blades 130-134. Later, dough strips 115 are cut crosswise (i.e., in a direction parallel to driveshaft 125) to form a plurality of dough pieces.

In particular, the dough engaging portion (not separately labeled but clearly shown in FIG. 3B) of each blade 130-134 draws or presses the upper dough skin toward the lower dough skin to pinch the two skins together while cutting. At the same time, first and second longitudinally extending dough strip sides (not separately labeled here but discussed further below) are formed from the upper dough skin for each dough strip or piece. By cutting the dough in this manner, the upper dough skin is stretched.

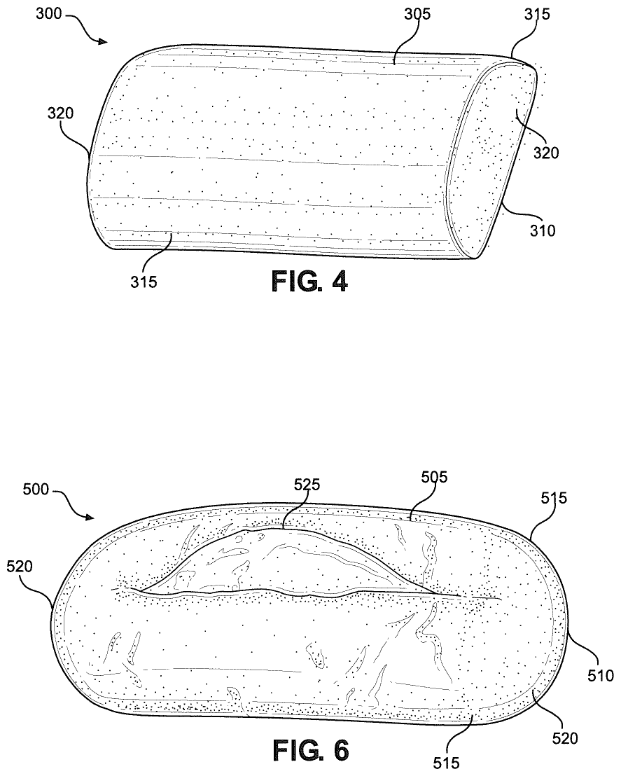

A dough piece produced in accordance with the present invention is shown in FIG. 4. In particular, a dough piece 300 has an upper surface or skin 305, a lower surface or skin 310 opposite upper surface or skin 305, opposing side surfaces 315, formed from the upper skin 305 and advantageously rounded due to the particular cutting arrangement, and opposing end surfaces 320. Side surfaces 315 were formed by two of blades 130-134 in step 1010, while end surfaces 320 were formed by another dough cutter (not shown) when one of strips 150-153 was cut crosswise in step 1015. This other cutter can take the form of a guillotine dough cutter, for example.

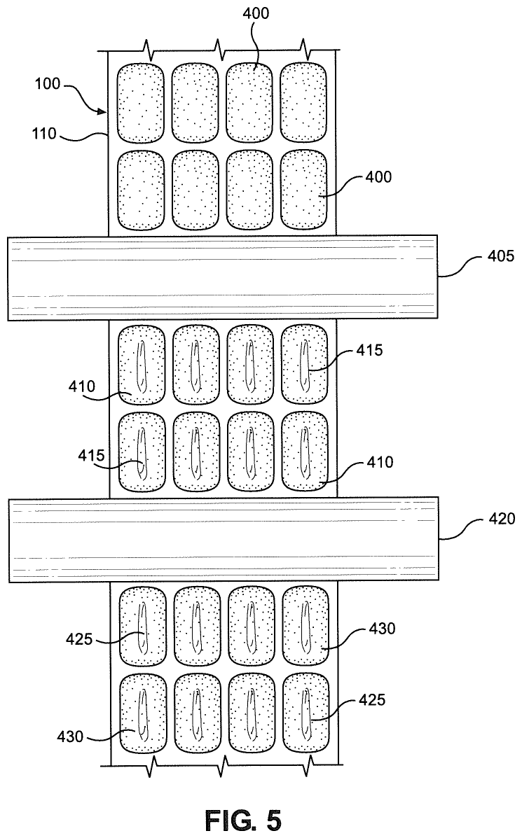

After formation of dough piece 300, dough piece 300 can be partially proofed and then frozen in steps 1020 and 1025. Once frozen, dough piece 300 is scored in step 1030, and, in some embodiments, a coating or treatment is applied to the score in step 1035. Eventually, dough piece 300 can be transported to a bakery operator, for example, who thaws, fully proofs, bakes and sells the resulting bread product. FIG. 5 depicts the portion of the production line where the scoring and coating steps take place, i.e., where steps 1030 and 1035 take place. Specifically, FIG. 5 shows a plurality of frozen dough pieces 400 being transported by conveyor system 100 beneath or through a scoring mechanism 405. Scoring mechanism 405 is configured to score each of frozen dough pieces 400 one or more times to produce scored dough pieces 410 having scores 415. Preferably, scoring mechanism 405 includes at least one metal saw blade, water knife or laser (not individually labeled) for each row of frozen dough pieces 400, i.e., for each of dough strips 150-153. The saw blades, water knives or lasers are used to form scores 415. Since dough pieces 400 are rigid at the time of scoring (by virtue of being frozen), they are not deformed by the scoring. In addition, performing the scoring on dough pieces that are frozen allows the location and profiles of scores 415 to be precisely controlled.

After scoring, scored dough pieces 410 are optionally transported by conveyor system 100 beneath or through a coating mechanism 420. Coating mechanism 420 is configured to apply one or more coatings or treatments 425 to each of scored dough pieces 410 to produce coated dough pieces 430. In particular, the coatings or treatments 425 are applied at scores 415. This is facilitated by the fact that scores 415 remain open after formation due to the rigidity of the frozen dough. The coating or treatments 425 can take various forms, for example butter, garlic sauce, or the like.

FIG. 6 shows a bread product produced in accordance with the present invention. Specifically, FIG. 6 shows a bread product 500, which corresponds to one of coated dough pieces 430 after baking. Like dough piece 300, bread product 500 has an upper surface 505, a lower surface 510, side surfaces 515 and end surfaces 520. In addition, in the central portion of bread product 500, what was once one of scores 415 has opened up, forming an opening or internal exposed region 525. This occurs during baking of dough piece 430 as dough piece 430 expands. In the embodiment illustrated, dough product 500 is in the form of an Italian roll. However, it should be recognized that other bread products can certainly be produced in accordance with the present invention.

Based on the above, it should be readily apparent that the present invention provides scored dough pieces where the scores are only formed after a freezing step and remain intact through later production steps, particularly thawing and proofing, as well as apparatuses and methods for producing the scored dough pieces. While certain preferred embodiments of the present invention have been set forth, it should be understood that various changes or modifications could be made without departing from the spirit of the present invention. In general, the invention is only intended to be limited by the scope of the following claims.

1. A method for producing a scored dough piece, the method comprising:
forming a dough piece;
freezing the dough piece to produce a frozen dough piece; and
scoring the frozen dough piece to produce a scored dough piece having at least one score.

2. The method of claim 1, further comprising applying a coating or treatment to the at least one score of the scored dough piece.

3. The method of claim 1, wherein scoring the frozen dough piece includes scoring the frozen dough piece with a saw blade.

4. The method of claim 1, wherein scoring the frozen dough piece includes scoring the frozen dough piece with a water knife.

5. The method of claim 1, wherein scoring the frozen dough piece includes scoring the frozen dough piece with a laser.

6. The method of claim 1, wherein forming the dough piece includes:
transporting a dough sheet with a conveyor system;
cutting the dough sheet to form a dough strip; and
cutting the dough strip to form the dough piece.

7. The method of claim 6, wherein cutting the dough sheet includes cutting the dough sheet with at least one circular blunt-edge cutter, and the at least one circular blunt-edge cutter is configured to cut the dough sheet as the at least one circular blunt-edge cutter rotates.

8. The method of claim 7, wherein the at least one circular blunt-edge cutter has a dough engaging portion which presses an upper skin of the dough piece toward a lower skin of the dough piece and pinches the upper and lower skins together in foiiiiing the dough piece.

9. The method of claim 1, further comprising partially proofing the dough piece before freezing the dough piece.

10. An automated production line for producing scored dough pieces, the production line comprising:
a freezer configured to freeze a dough piece to produce a frozen dough piece; and
a scoring mechanism configured to score the frozen dough piece to produce a scored dough piece having at least one score.

11. The production line of claim 10, further comprising a coating mechanism configured to apply a coating or treatment to the at least one score of the scored dough piece.

12. The production line of claim 10, wherein the scoring mechanism includes a saw blade.

13. The production line of claim 10, wherein the scoring mechanism includes a water knife.

14. The production line of claim 10, wherein the scoring mechanism includes a laser.

15. The production line of claim 10, further comprising:
a conveyor system configured to transport a dough sheet;
a first cutting mechanism configured to cut the dough sheet to form a dough strip; and
a second cutting mechanism configured to cut the dough strip to form the dough piece.

16. The production line of claim 15, wherein the first cutting mechanism includes at least one circular blunt-edge cutter, and the at least one circular blunt-edge cutter is configured to cut the dough sheet as the at least one circular blunt-edge cutter rotates.

17. The production line of claim 16, wherein the at least one circular blunt-edge cutter has a dough engaging portion configured to press an upper skin of the dough piece toward a lower skin of the dough piece to pinch the upper and lower skins together in forming the dough piece.

18. The production line of claim 10, wherein the production line is configured to partially proof the dough piece before freezing the dough piece.
